(19) United States
(12) Patent Application Publication
(10) Pub. No.: US 2009/0321274 A1
(43) Pub. Date: Dec. 31, 2009

(54) Machine And Method For Electrochemically Polishing Indentations Within An Aluminum Wheel

(75) Inventors: Steven J. Comaty, Rochester Hills, MI (US); James Koroskenyi, Pittsburgh, PA (US); Horst Kissel, Rochester Hills, MI (US)

Correspondence Address: KENNAMETAL INC.;Intellectual Property Department, P.O. BOX 231, 1600 TECHNOLOGY WAY, LATROBE, PA, 15650, US

(73) Assignee: Kennametal Inc., Latrobe, PA (US)

(21) Appl. No.: 12/555,202

(22) Filed: Sep. 8, 2009

Related U.S. Application Data
(63) Continuation of application No. 11/466,897, filed on Aug. 24, 2006.

(51) Int. Cl. B23H 3/02; C25C 3/20

(52) U.S. Cl. 205/649; 204/230.2

(57) ABSTRACT

A machine for electrochemically polishing indentations within the wall of an aluminum workpiece, such as a wheel, has a cathode attached to an upper platen. The workpiece is mounted upon a lower platen which acts as an anode. Electrolyte is passed between the cathode and the anode while simultaneously a current is applied which passes through the cathode and the anode. The current is selectively pulsed to maximize polishing but at the same time to permit the flushing away of residual material and to cool the cathode and the workpiece.

### BACKGROUND OF THE INVENTION

1. Field of the Invention

The present invention relates generally to electrochemical polishing and more specifically to electrochemically polishing aluminum wheels.

2. Description of Related Art

Electrochemical machining (ECM) is a process for removing material from a metal workpiece to impart a smooth surface which appears to be polished. Such a process takes place using an electrolyte having a high ionic strength. The workpiece to be machined serves as the anode and the electrode of the electrochemical machining apparatus serves as the cathode. In the polishing process an electric current runs between the anode and the cathode. Under these conditions, the electrode serves as a shaping tool. The workpiece, which serves as the anode, dissolves locally, for example, in the form of metal hydroxide while hydrogen is formed at the electrode surface. This electrochemical machining method enables patterns or arbitrarily shaped holes to be formed in a metal workpiece in a relatively simple and accurate manner. The electrochemical machining process may also be used to polish a workpiece by removing less material from the workpiece with the goal of achieving a smoother surface finish, as opposed to purely removing material to produce a predetermined shape.

However, electrochemically polishing large workpieces requires a large current and in the past, as a result of such a limitation, electrochemical polishing has been limited to relatively small surfaces. Additionally, with a continuous current, material is removed from the workpiece and the electrolyte always contains residue of the workpiece.

A method and apparatus are needed, whereby a larger workpiece, such as a wheel, may be electrochemically polished in an efficient manner that removes residue and that results in a superior finish.

### SUMMARY OF THE INVENTION

One embodiment of the subject invention is directed to a machine for electrochemically polishing indentations of known geometry within the wall of an aluminum workpiece, such as a wheel. The workpiece space defines the space in which a workpiece would occupy in the machine. The machine has an upper platen with a cathode extending from the upper platen, wherein the cathode is associated with an indentation and, wherein the cathode has a shape similar to that of the indentation but smaller and is adapted to be positioned adjacent to the indentation to define a gap therebetween for the introduction of an electrolyte between the cathode and the indentation. A lower platen is aligned with the upper platen, wherein the lower platen is adapted to receive the wheel and, wherein the upper platen and the lower platen are movable relative to one another such that, in a first position, the cathode may be distanced from the lower platen and, in a second position, the cathode is close to the lower platen with the cathode adjacent to the location of the indentation of the workpiece mounted to the lower platen The machine also has anode shoes for contact with the wheel, wherein the shoes are electrically conductive such that when the shoes contact the workpieces, the workpiece itself acts as an anode. An entry passageway introduces electrolyte within the gap between the cathode and the indentation of the workpiece and an exit passageway removes electrolyte from the gap between the cathode and the indentation of the workpiece. A power supply provides current between the cathode of the upper platen and the anode of the lower platen through electrolyte therebetween and a controller controls the current between the cathode and the anode.

Another embodiment of the subject invention is directed to a method for electrochemically polishing indentations of known geometry within the wall of an aluminum workpiece. A workpiece space defines the space in which the workpiece would occupy in the machine. The method comprises the steps of:
a) mounting an aluminum workpiece upon a platen;
b) attaching at least one anode to the workpiece;
c) positioning at least one cathode within the indentation within the workpiece, thereby defining a gap between the cathode and the anode;
d) introducing a flow of electrolyte within the gap;
e) introducing a current between the cathode and the anode; and
f) pulsing the current to permit the flowing electrolyte to flush the indentation surface.

### BRIEF DESCRIPTION OF THE SEVERAL VIEWS OF THE DRAWINGS

FIG. 1 is a front view of a typical wheel that may be polished using the machine and method in accordance with the subject invention;

FIG. 2 is an enlarged section of a portion of the wheel illustrated in FIG. 2;

FIG. 3 is a perspective view of a portion of the top platen with an anode extending therefrom;

FIG. 4 is a sketch of the apparatus in accordance with the subject invention;

FIG. 5 is a sketch of the machine illustrated in FIG. 4 but with the upper platen and lower platen adjacent to each other to perform the machining process; and

FIG. 6 is a plan view of a cathode used to polish a closed pocket.

### DETAILED DESCRIPTION OF THE INVENTION

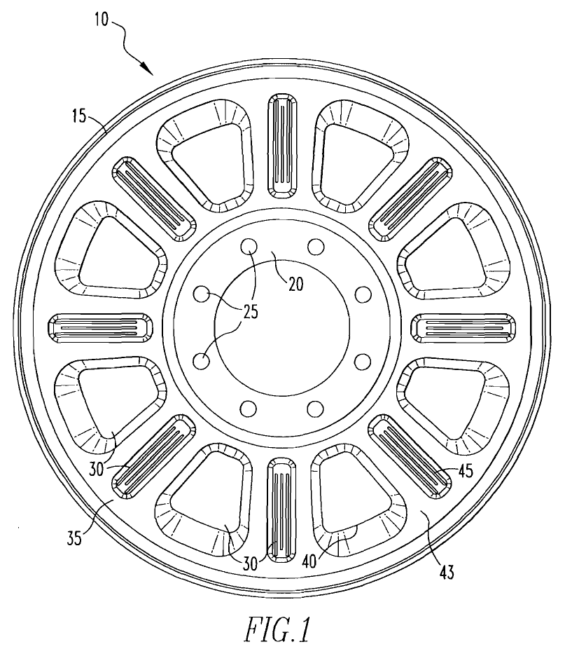

FIGS. 1 and 2 illustrate details of a typical workpiece, such as a wheel 10, which in these figures is an aluminum wheel having a cylindrical profile defining a wheel rim 15 which supports a tire (not shown) and a hub 20 having a plurality of lug holes 25 extending therethrough for securing the wheel 10 with lugs (not shown) extending from the body of a vehicle.

The wheel 10 has a plurality of indentations 30 of known geometry within the wall 35 of the wheel 10. In particular, an indentation 30 may be either a window 40 extending through the wall 35 of the wheel 10 or a pocket 45 which extends only partially through the wall 35 of the wheel 10. It should be appreciated that the electrochemical polishing process associated with the window 40 is slightly different than the process associated with the pocket 45. In particular, the electrolyte may be flushed through the window 40 during the process while the electrolyte must be introduced and removed from the pocket 45.

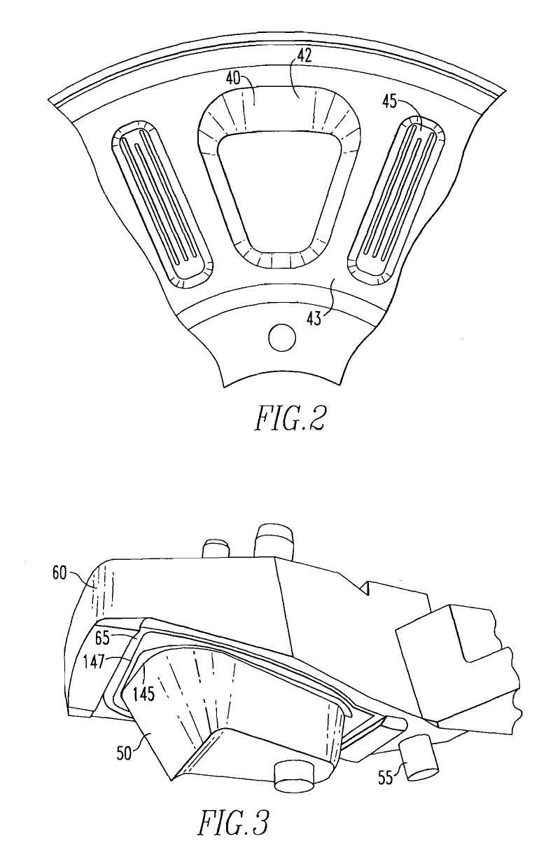

For the electrochemical process to be effective, it is necessary for the anode to conform fairly closely to the shape of the workpiece to be polished. Directing attention to FIG. 3, the cathode 50 is shaped to have a substantially similar profile to that of the window 40 (FIG. 2). The cathode 50 must be slightly smaller than the profile of the window 40 to create a gap. The gap exists for two reasons. First of all, it is necessary to introduce an electrolyte within the gap to promote the chemical reaction which removes material from the window 40. Second of all, the gap must be maintained to prevent electrical arcing between the cathode and the anode since such arcing would pit the walls 42 of the window 40. Cathodes 50 are typically made of solid brass.

Briefly turning to FIG. 1 and with respect to FIG. 3, it should be apparent that the cathode 50 may be placed in any one of the windows 40 and the locator pin 55 on the upper platen may be placed within the lug hole 25 to properly space the cathode 50. The cathode 50 is attached to an upper platen 60. The upper platen 60 has surfaces 65 which contact the perimeter 43 of the window to vertically position the cathode 50 within the window 40.

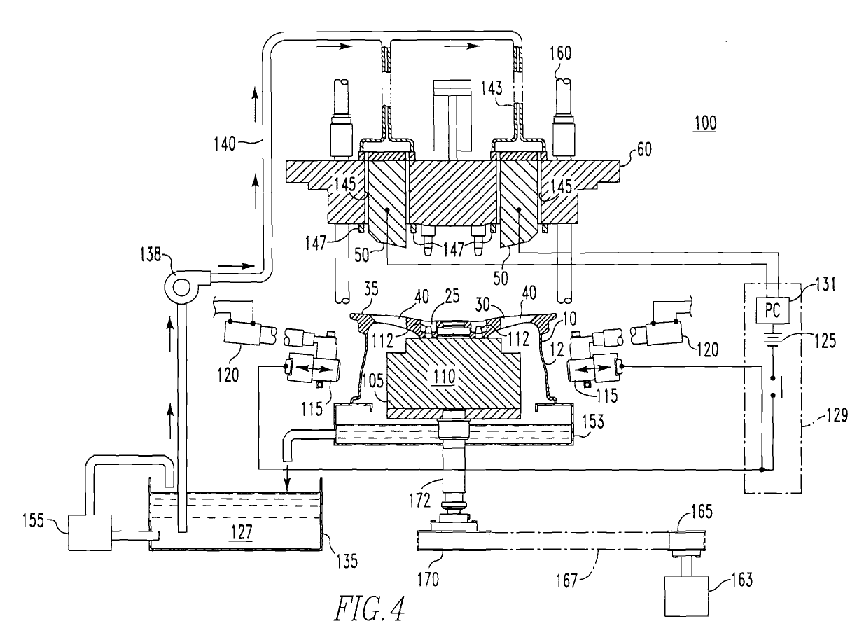

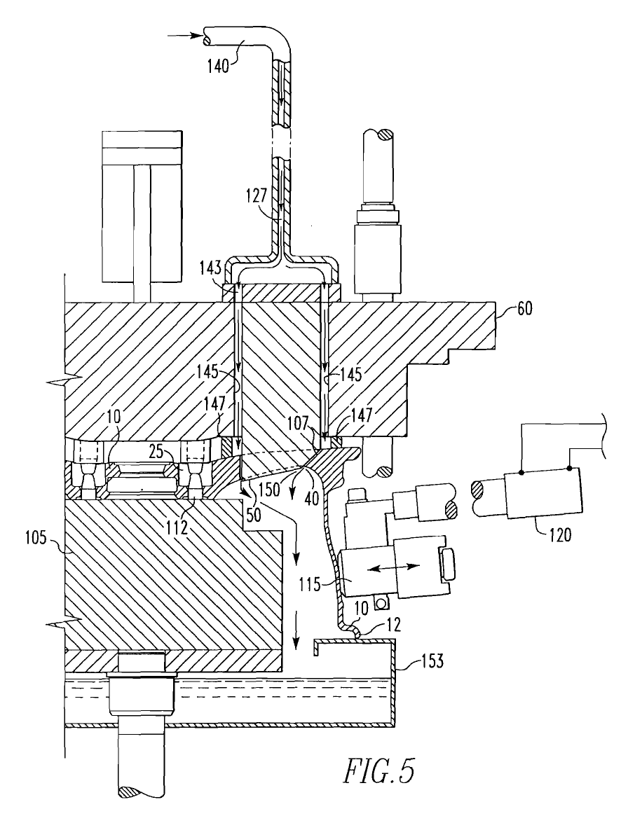

Directing attention to FIG. 4, a machine 100 is illustrated for electrochemically polishing indentations 30 such as the window 40 of known geometry within the wall 35 of an aluminum wheel 10. A wheel space 12 is used to define the volume that would be occupied when an actual wheel 10 is placed within the machine 100. The machine 100 has an upper platen 60 with two cathodes 50 extending therefrom. Each cathode 50 is associated with an indentation 30 and each cathode 50 has a shape similar to that of the indentation 30, but smaller. Each cathode 50 is adapted to be positioned adjacent to the indentation 30 to define a gap therebetween, for the introduction of an electrolyte between the cathode 50 and the indentation 30.

A lower platen 105 is aligned with the upper platen 60. The lower platen 105 is adapted to receive the wheel 10. The upper platen 60 and the lower platen 105 are movable relative to one another such that, in a first position (FIG. 4), the cathodes 50 may be distant from the lower platen 105 and, in a second position (FIG. 5), the cathodes 50 on the upper platen 60 are close to the lower platen 105 and within the indentations 30 of a wheel 10 mounted to the lower platen 105. In FIGS. 4 and 5, the indentation 30 is the window 40. This positioning provides a gap 107 through which electrolyte may flow to transmit current therebetween.

FIG. 4 illustrates the machine 100 in a first position with the cathodes 50 distanced from the lower platen 105. This arrangement is used for set-up so that the wheel 10 may be introduced to or removed from the lower platen 105. The lower platen provides a non-conductive base 110, which may be a glass-filled phenolic material, with locating bolts 112 protruding therefrom which engage one or more of the lug holes 25 in the wheel 10. The machine 100 includes anode shoes 115 which contact the wheel 10. The shoes 115 are electrically conductive such that when the shoes 115 contact the wheel 10, the wheel 10 itself acts as an anode. The anode shoes 115 are movable from a first position illustrated in FIG. 4, wherein the shoes 115 are away from the wheel 10 to a second position (FIG. 5), wherein the shoes 115 contact the wheel 10. It should be appreciated that in the event the wheel 10 is not mounted within the machine 100, the anode shoes in the second position would be positioned within a wheel space 12 identical to the location of the wheel 10.

The anode shoes 115 are attached to linear cylinders 120 capable of indexing the anode shoes 115 in the first position, as illustrated in FIG. 4, or in the second position, as illustrated in FIG. 5. A power supply 125 provides current between the cathode 50 of the upper platen 60 and the anode 115 of the lower platen 105, but permits such current to pass between these two parts through the introduction of electrolyte therebetween. The combination of the electrolyte 127 therebetween and a current passing between the cathode 50 and the wheel 10, which acts as the anode through the electrolyte 127, promotes the chemical reaction which removes material from the window 40 of the wheel 10. A controller 129 controls the current between the cathode 50 and the wheel 10 acting as an anode.

In order to promote the quality of polishing provided by the machine 100, the controller 129 further includes a pulsing circuit 131 for allowing the current to be intermittently applied to the cathode 50, thereby permitting the electrolyte 127 to more effectively flush residue from the wheel 10. The controller 129 provides at least a machining mode and a polishing mode. In the machining mode, the current is high to remove a substantial amount of material from the wheel 10. In the polishing mode, the current is lower to remove a substantially less amount of material from the wheel 10. As a result, a wheel 10 with a relatively rough finish may first be “machined” and then “polished” to produce a finished product. With such a two-stop process, it may be possible to eliminate a preliminary mechanical grinding step which heretofore preceded the electrochemical machining process.

While the parameters for pulsing the current used for this process is dependent upon a variety of factors such as workpiece size, the gap between the cathode and the workpiece and the composition of the electrolyte, in general, the pulsing of the current for the machining mode is approximately 50 milliseconds on and 25 milliseconds off for a typical workpiece. For the polishing mode, the pulsing of the current is approximately 40 milliseconds on and 20 milliseconds off. Overall, the current may be pulsed at a rate of between 20-25 milliseconds on and 8-30 milliseconds off. The inventors have discovered that the pulsing process itself greatly improves the efficiency of the polishing process and that this two stage machining/polishing method further enhances the effectiveness of the pulsing process.

Additionally, as a general guideline for a typical workpiece, the current may be between 12,000-15,000 amperes and the voltage may be between approximately 0-25 volts direct current.

It should be appreciated that a flow of electrolyte 127 is necessary for normal operation of the machine 100. The flow of electrolyte 127 not only promotes the transfer of current between the anode and the wheel 10, but furthermore, provides a mechanism for removing heat and residue from the working region of the wheel 10.

Directing attention to FIG. 4, from a reservoir 135 electrolyte 127 is delivered through a pump 138 through a conduit 140 to an entry passageway 143, which in FIG. 4 is a sleeve 145 surrounding each cathode 50 so that the electrolyte 127 may be introduced around the perimeter of the cathode 50. FIG. 3 further illustrates that this sleeve 145 extends through the upper platen 60 and surrounds the cathode 50. It should be noted in FIG. 3 that a seal 147 surrounds the sleeve 145. The seal 147 is comprised of a flexible nonporous material surrounding the cathode 50 and entry passageway 143. While the sleeve 145 is illustrated as the mechanism for dispersing the electrolyte 127 about the perimeter of the cathode 50, this sleeve 145 may in the alternative be a plurality of ports about the perimeter of the cathode 50 to achieve the same result. The entry passageway 143 conforms to the perimeter of the cathode 50 and when a cathode 50 having a different geometry is used, the associated entry passageway 143 again conforms to the perimeter of the new cathode 50.

Directing attention to FIG. 5, when the upper platen 60 is positioned against the wheel 10, the seal 147 is urged against the wheel 10 thereby providing a watertight seal between the upper platen 60 the wheel 10 to contain the electrolyte 127. Examining both FIGS. 4 and 5, the electrolyte 127 travels through the sleeve 145 around the cathode 50 and through an exit passageway 150 which in FIG. 4 is the window 40 of the wheel 10. In this arrangement, the electrolyte 127 may be drained through the window 40 into a collection tank 153 where it is then returned to the reservoir 135 to be used again. As illustrated in FIG. 4, the electrolyte 127 in the reservoir 135 is diverted to a reclamation station 155 to remove impurities from the electrolyte 127 that were introduced during the polishing process. One reclamation technique involves the introduction of iron nitrate with the spent electrolyte after which time the fluid is centrifuged. This technique is better described in a co-pending U.S. patent application Ser. No. 11/465,839 titled “Process For Regenerating Electrolytes In Electrochemical Polishing Applications” filed Aug. 21, 2006 and assigned to the same assignee as the present application. It should also be noted in FIG. 4 that the wheel 10 rests upon the collector tank 153, such that the wheel 10 provides a seal against the tank 153 to minimize the loss of electrolyte.

The cathodes 50 of the subject invention are customized to act upon the window 40 of the wheel 10, illustrated in FIGS. 1 and 2. It should be appreciated that each cathode 50 is removable and may be replaced with a differently shaped cathode to accommodate indentations of different shapes on wheels. FIGS. 3, 4 and 5 illustrate the cathode 50, which is removably attached to the upper platen 60. The upper platen 60 is slideably mounted upon posts 160 so that it may be moved between the first position, wherein the upper platen 60 is spaced from the wheel 10 (FIG. 4), then to the second position, wherein the upper platen 60 is adjacent to the wheel 10 (FIG. 5). It should also be appreciated that the upper platen 60 and the lower platen 105 are electrically insulated from the anode, which is the wheel 10, and from the cathodes 50.

From inspection of FIG. 1, it is apparent that there are multiple windows 40 within a wheel 10. In one embodiment of the subject invention, two windows 40 are polished simultaneously although a single window may also be polished. The subject invention is also designed to index the wheel 10 or another workpiece so that different windows can be polished by the same cathode. However, because the electrochemical polishing process requires a high current, prior art designs for electrochemical polishing use a single cathode. Additionally, the lower platen 105 is indexable such that wheel 10 having multiple indentations 30 may be rotated to align different indentations 30 with the cathodes 50 for polishing. In particular, a CNC controlled servo-drive motor 163 drives a pulley 165 which drives a belt 167 to rotate a second pulley 170 which rotates a shaft 172, thereby rotating the lower platen 105 and the wheel 10 attached thereto. By doing so, it is possible to index the wheel 10 so that different windows 40 are aligned with the cathodes 50 for polishing. As a result, polishing the eight windows 40 in the wheel 10, illustrated in FIG. 1, requires indexing the wheel 10 only four times as opposed to indexing the wheel 10 eight times when there is a single cathode 50 operating upon a window 40.

The electrolyte 127 is comprised of a solution of sodium nitrate (NaNO₃) and water. The flow of electrolyte 127 for a typical application may be between 25-55 gallons per minute. As a particular example, for a wheel 10 having a diameter of 20 inches and indentations 30 proportional to that size, the flow of electrolyte may be between 45-50 gallons per minute. For a wheel 10 having a diameter of 18 inches and indentations 30 proportional to that size, the flow of electrolyte may be between 30-35 gallons per minute. The gap 107 between the cathode 50 and the wall 35 of the window 40 is typically about 0.75 millimeters, however, in regions where a greater degree of polishing is required during the operation, this gap may be slightly smaller, keeping in mind that a gap that is too small will result in undesirable arcing between the cathode 50 and the anode, which is the wheel 10.

With the electrolyte 127 flowing around the cathodes 50, the pulsing circuit 131 of the controller 129 is capable of turning the current on and off so that the electrolyte has a chance not only to cool the wheel 10, but furthermore, to wash away any impurities it may have accumulated on the wall 35 of the window 40 in the wheel 10.

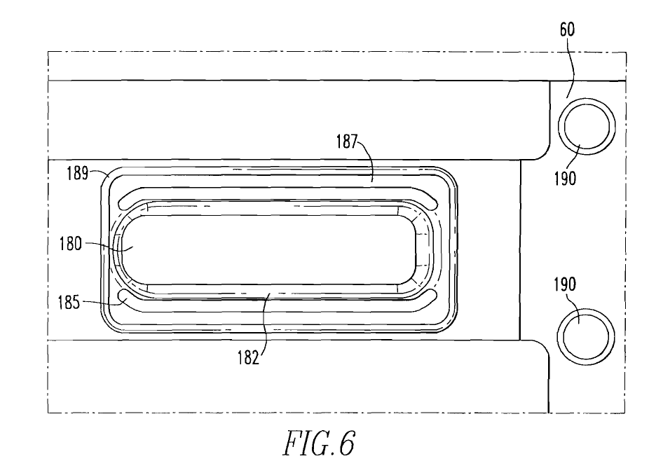

So far the discussion has been directed to electrochemically polishing a window 40 within a wheel 10. As illustrated in FIGS. 1 and 2, the indentation 30 may also be a pocket 45 which does not extend through the wall 135 of the wheel 10. As a result, for polishing a pocket 45, the electrolyte 127 must be directed in a different fashion. FIG. 6 illustrates the upper platen 60 having a cathode 180 extending therefrom. A seal 182 surrounds the cathode 180 to provide a water-tight seal when the upper platen 60 is placed over the pocket 45. The purpose of this design is to deliver electrolyte 127 over the sides and the face of the cathode 180. In particular, an entry passageway 185 on one side of the cathode 180 introduces the electrolyte 127 to what is now an enclosed chamber 187. The electrolyte 127 flows across the cathode 180 and is removed from the chamber 187 through an exit passageway 189 where the electrolyte is then delivered to the collection tank 153, illustrated in FIG. 4. With respect to the wheel 10 illustrated in FIG. 1, the upper platen 60 illustrated in FIG. 6, has two locating pins 190 (FIG. 6), which fit within the lug holes 25 adjacent to the pocket 45 to be polished.

The subject invention is also directed to a method for electrochemically polishing indentations 30 of known geometry within the wall 35 of an aluminum wheel 10. A wheel space defines the space in which a wheel 10 would occupy in the machine 100. The method is comprised of the steps of mounting an aluminum wheel 10 upon a platen 105 and attaching at least one anode through, for example, anode shoe 115 to the wheel 10. At least one cathode 50 is positioned within the indentation 30 of the wheel 10, thereby defining a gap 107 between the cathode 50 and the anode. An electrolyte 127 is introduced within the gap and a current is then introduced between the cathode 50 and the anode. The current is pulsated to permit the flowing electrolyte 127 to flush impurities from the surface of the indentation 30. The electrolyte is recirculated during the polishing process, but furthermore, the electrolyte is reclaimed through a reclamation process, such as that process previously described herein.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

1. A machine for electrochemically polishing indentations of known geometry within the wall of an aluminum workpiece, wherein a workpiece space defines the space in which a workpiece would occupy in the machine and wherein the machine comprises:
a) an upper platen;
b) at least two cathodes extending from the upper platen, wherein each cathode is associated with an indentation and wherein each cathode has a shape similar to that of the indentation but smaller and is adapted to be positioned adjacent to the indentation to define a gap therebetween for the introduction of an electrolyte between the cathode and the indentation;
c) a lower platen aligned with the upper platen, wherein the lower platen is adapted to receive the workpiece and wherein the upper platen and the lower platen are movable relative to one another such that in a first position the cathodes may be distanced from the lower platen and in a second position the cathodes are close to the lower platen with the cathodes adjacent to the location of the indentation of a workpiece mounted to the lower platen;
d) anode shoes for contact with the workpiece, wherein the shoes are electrically conductive such that when the shoes contact the workpieces, the workpiece itself acts as an anode;
e) an entry passageway to introduce electrolyte within the gap between the cathode and the indentation of the workpiece;
f) an exit passageway to remove electrolyte from the gap between the cathode and the indentation of the workpiece;
g) a power supply to provide current between the cathode of the upper platen and the anode of the lower platen through the electrolyte therebetween; and
h) a controller for controlling the current between the cathode and the anode.

2. The machine according to claim 1, wherein the workpiece is a wheel.

3. (canceled)

4. The machine according to claim 1, wherein the controller further includes a pulsing circuit for allowing the current to be intermittently applied to the cathode thereby permitting the electrolyte to more effectively flush residue from the anode.

5. The machine according to claim 4, wherein the controller has at least a machining mode and a polishing mode, and wherein in the machining mode, the current is high to remove a substantial amount of material from the workpiece while, in a polishing mode, the current is lower to remove a substantially less amount of material from the workpiece

6. The machine according to claim 1, wherein the indentation is a window extending through the wall of the workpiece, the entry passageway surrounds the cathode so that the electrolyte may be introduced around the perimeter of the cathode, and the exit passageway is the window so that the electrolyte may be drained through the window.

7. The machine according to claim 6, wherein the passageway is a series of ports about the perimeter of the cathode.

8. The machine according to claim 6, wherein the passageway is a sleeve about the perimeter of the cathode.

9. The machine according to claim 1, wherein the indentation is a pocket in the wall of the workpiece, the entry passageway is a slot on one side of the pocket and the exit passageway is a slot on the opposite side of the pocket such that electrolyte may be introduced within the gap from one side of the pocket and discharged from the opposing side of the pocket.

10. The machine according to claim 1, wherein the cathode is removably attached to the upper platen so that different cathodes may be installed to accommodate indentations of different shapes.

11. The machine according to claim 1, wherein the upper platen is slidably mounted for moving between the first position and the second position.

12. The machine according to claim 1, wherein the upper platen and the lower platen are electrically insulated from the anodes and the cathodes attached thereto.

13. The machine according to claim 1, further including flexible non-porous material surrounding each cathode and entry passageway, wherein the material is adapted to mate against the workpiece to provide a water-tight seal between the upper platen and the workpiece.

14. The machine according to claim 1, wherein the anode shoes are movable from a first position away from the workpiece space to a second position within the workpiece space such that the shoes would contact a workpiece mounted within the workpiece space.

15. The machine according to claim 1, wherein the lower platen is indexable such that a workpiece having multiple indentations may be rotated to align different indentations with the cathode.

16. The machine according to claim 1, further including a collector tank for collecting electrolyte after it has passed through the gap between the cathode and the anode.

17. A method for electrochemically polishing indentations of known geometry within the wall of an aluminum workpiece, wherein a workpiece space defines the space in which a workpiece would occupy in the machine and wherein the method comprises the steps of:
a) mounting an aluminum workpiece upon a platen;
b) attaching at least one anode to the workpiece;
c) positioning at least one cathode within an indentation of the workpiece, thereby defining a gap between the cathode and the anode;
d) introducing a flow of electrolyte within the gap;
e) introducing a current between the cathode and the anode; and
f) pulsing the current to permit the flowing electrolyte to flush the indentation surface.

18. The method according to claim 17, wherein the workpiece is a wheel.

19. The method according to claim 17, wherein the step of pulsing the current is a two step process in which in a machining step the current is greater to remove a substantial amount of material while in a subsequent polishing step the current is less to remove a substantially less amount of material.

20. The method according to claim 19, wherein the current for the machining step is approximately 50 milliseconds on and 25 milliseconds off.

21. The method according to claim 19, wherein the current for the polishing step is approximately 40 milliseconds on and 20 milliseconds off.

22. The method according to claim 17, wherein the current is between approximately 12,000 and 15,000 amperes and the voltage is between approximately 0 and 25 volts direct current.

23. The method according to claim 17, wherein the current is pulsed at a rate of between approximately 20-25 milliseconds on and between approximately 8-30 milliseconds off.

24. The method according to claim 17, wherein the flow of electrolyte is in the range of 25-55 gallons per minute.

25. The method according to claim 18, wherein for a wheel having a diameter of 20 inches, the flow rate is between 45-50 gallons per minute.

26. The method according to claim 18, wherein for a wheel having a diameter of 18 inches, the flow rate is between 30-35 gallons per minute.

27. The method according to claim 17, wherein the electrolyte is recirculated to provide electrolyte within the gap.

28. The method according to claim 17, wherein the electrolyte is filtered to remove residue before recirculation.

30. A method for electrochemically polishing indentations of known geometry within the wall of an aluminum workpiece, wherein a workpiece space defines the space in which a workpiece would occupy in the machine and wherein the method comprises the steps of:
a) mounting an aluminum workpiece upon a platen;
b) attaching at least one anode to the workpiece;
c) positioning at least one cathode within the indentation within the workpiece, thereby defining a gap between the cathode and the anode;
d) introducing a flow of electrolyte within the gap; and
e) introducing a pulsing current between the cathode and the anode, wherein the current is on for a predetermined period to polish the workpiece indentation and then off for a predetermined shorter period to permit the flowing electrolyte to flush the indentation surface.

31. A machine for electrochemically polishing indentations of known geometry within the wall of an aluminum workpiece, wherein a workpiece space defines the space in which a workpiece would occupy in the machine and, wherein the machine comprises:
a) an upper platen;
b) at least two cathodes extending from the upper platen, wherein each cathode is associated with an indentation and, wherein each cathode has a shape similar to that of the indentation but smaller and is adapted to be positioned adjacent to the indentation to define a gap therebetween for the introduction of an electrolyte between the cathode and the indentation;
c) a lower platen aligned with the upper platen, wherein the lower platen is adapted to receive the workpiece and, wherein the upper platen and the lower platen are movable relative to one another only along a single axis, such that in a first position the cathodes may be distanced from the lower platen and in a second position the cathodes are close to the lower platen with the cathodes adjacent to the location of the indentation of a workpiece mounted to the lower platen;
d) anode shoes for contact with the workpiece, wherein the shoes are electrically conductive such that when the shoes contact the workpieces, the workpiece itself acts as an anode;
e) an entry passageway to introduce electrolyte within the gap between the cathode and the indentation of the workpiece;
f) an exit passageway to remove electrolyte from the gap between the cathode and the indentation of the workpiece;
g) a power supply to provide current between the cathode of the upper platen and the anode of the lower platen through the electrolyte therebetween; and
h) a controller for controlling the current between the cathode and the anode.

32. The machine according to claim 1, wherein the anode shoes are each attached to a respective linear cylinder, the linear cylinders indexing the anode shoes between a first position retracted from the workpiece and a second position in contact with the workpiece.
